(19) United States
(12) Patent Application Publication
(10) Pub. No.: US 2001/0051567 A1
(43) Pub. Date: Dec. 13, 2001

(54) Roller with ink-repellent coating

(76) Inventor: Hnas-Jurgen Schaschke, Hemmingen (DE)

Correspondence Address: Connolly Bove Lodge & Hutz LLP, P.O. Box 2207, Wilmington, DE, 19899-2207, US

(21) Appl. No.: 09/764,974

(22) Filed: Jan. 18, 2001

(30) Foreign Application Priority Data
Jan. 24, 2000 (DE) 100 02 683.4

(51) Int. Cl. B25F 5/02; B21K 1/02; B21D 53/00

(52) U.S. Cl. 492/56; 492/59; 29/895.32; 29/895.3

(57) ABSTRACT

A roller comprising a roller core and a roller covering being composed of an elastomer or elastic plastic material is characterized in that the elastomer or elastic plastic material of the roller covering cadditionally comprises fluorinated polyolefin. Preferably, from 0.2 to 25% by weight of a fluorocarbon plastic, in particular of polytetrafluoroethylene powder or fiber, is incorporated into the roller coating material to improve the ink-repellent properties of the roller covering. In one embodiment, the fluorinated polyolefin is employed in the form of a fibrous material, e.g. a web or the like, provided with the coating material and wrapped around the roller to form a surface layer.

This application claims benefit to German application number DE 100 02 683.4 filed Jan. 24, 2000 which is incorporated by reference in its entirety for all useful purposes.

### FIELD OF THE INVENTION

The present invention relates to a roller with a covering made of elastomers or elastic plastic materials having ink-repellent properties and to methods of using and making such roller.

### BACKGROUND

When offset printing is used, the image and typeface elements are transferred photomechanically onto a sensitized printing plate. This printing plate, a flexible multi-metal offset plate, will be attached to the plate cylinder in the printing machine. The printed image will be generated during the printing process by inking the sensitized spots on the printing plate. This image will first of all be transferred onto a rubber blanket (the so-called offset blanket, which has also been attached to a cylinder) and then to the material to be actually printed. During this process, the printing plate will be continuously wetted with a wetting agent, usually fountain solution, so that an ink-repellent wet film is formed on the areas which are not to be printed.

A dampening system with alternating rollers having a metallic surface or being coated with elastomer or elastic plastic material makes sure that the printing plate is always wetted to the extent necessary. The rollers being coated with elastomer or elastic plastic material, which are referred to hereafter as dampening rollers, are e.g. called dampening form roller, metering roller or ductor roller, depending on their function in the dampening system. It is the rollers' job in the dampening system, to spread the fountain solution continuously and with the same intensity over the plate cylinder at all speeds. It must be prevented that ink can spill from the printing plate into the dampening system, which would pollute the fountain solution and potentially damage the dampening rollers. However, it is acceptable and desirable at the moment that the fountain solution and the ink can mix to a certain extent and form an emulsion on the surface of the dampening form roller.

To wet the surface of the dampening rollers properly, special additives are admixed to the fountain solution, often also isopropyl alcohol (IPA) in quantities of between 0 and 15% by volume. Besides, special roller coatings have been developed to improve the surface properties of the fountain solution during this process. However, all attempts to improve the surface properties of the coating for dampening rollers to such an extent that they are ink-repellent have not been so successful that an extensive cleaning (of the rollers) could be avoided. As the printing process will have to be interrupted during the cleaning of the dampening rollers, considerable downtime costs are incurred.

EP 841147 A2 introduces a roller coated with elastomer, which has been covered in a special process with an anti-adhesive fluoropolymer layer. During this process, a fluoropolymer tube is drawn over an elastomer-coated roller and subsequently bonded to it. Not only is this process rather costly, as the entire surface of the roller will have to be coated with the fluoropolymer, the fluoropolymer coat is also relatively hard so that the rollers coated in this way cannot be used as dampening rollers in offset printing machines.

According to U.S. Pat. No. 6,141,873, a multi-layer roll is obtained by applying a fibrillated PTFE (polytetrafluoroethylene) membrane to a silicone rubber baselayer. Again, the hardness of the PTFE layer is to high to use such rollers as dampening rollers. Further, the PTFE membrane and the production process are rather costly.

U.S. Pat. No. 5,320,042 discloses a paper web guide roller having layers made of ultra-high molecular plastic, in particular of polyethylene or PTFE, which are applied by a thermal spray process. The layers have a thickness of about 0.2 to 1 mm. In the surface layer glass balls are embedded to adjust slipping and friction properties with respect to the paper web. The described layers, however, do not comprise elastomers or elastic plastic material.

Blends of PTFE and elastomers or of a fluoropolymer and a rubber modified thermoplastic resin are described in U.S. Pat. Nos. 5,399,400 and 5,962,587, respectively. These blends, however, are made to either obtain thin walled articles with improved tear strength or to impart a high tensile modulus, ductility and a low friction surface to articles molded therefrom.

### THE INVENTION

It is an object of the present invention to improve the covering of rollers, particularly of dampening rollers, to such an extent that they become repellent to inks and other media. It is further intended to markedly lengthen the cleaning intervals, especially of the dampening rollers, while the high quality of the dampening process itself is retained, and to reduce the cleaning costs considerably that way. Surprisingly, this object has been accomplished by adding fluorinated polyolefin to the roller covering.

The invention thus relates to a roller which is covered with elastomer or elastic plastic material, but with the elastomer or the elastic plastic material additionally containing fluorinated polyolefin. The invention also facilitates a method of use of the roller according to the invention as a dampening roller in offset printing machines, and methods of making the roller according to the invention.

Surprisingly, it was discovered that by adding fluorinated polyolefin to the coating material of rollers ink-repellent properties are imparted to the roller covering in a rather inexpensive way.

The invention will be further disclosed in the subsequent description and in the patent claims.

### DETAILED DESCRIPTION

Rollers and their design are well known to the expert. They comprise a roller core and a roller covering. The roller core may be manufactured from either metallic materials or thermoplastic or duroplastic materials, the latter being advantageously reinforced by fibers. Preferably such roller cores are made of glass-fiber or carbon-fiber reinforced plastics.

According to the invention, the roller covering is made of natural rubber (NR), synthetic rubber, e.g. acrylonitrile butadiene rubber (NBR, HNBR, XNBR), ethylene rubber (CM, CSM), ethylene propylene rubber (EPM, EPDM), styrene butadiene rubber (SBR), butyl rubber (IIR), polyurethane rubber (PUR), polyacrylic rubber (ACM), epichlorohydrine rubber (CO, ECO), silicone rubber (Q, VQ, MQ etc.) or chloroprene rubber (CR), elastic thermoplastics, such as polyvinyl chloride (PVC), thermoplastic elastomers (TPE), such as elastificated polyolefin, styrene block copolymer, copolyester elastomer or thermoplastic polyurethane (TPU), as well as of castable two-component or multi-component polyurethane systems or of a suitable mixtures of the mentioned materials. Such materials are well known to the expert and described, e.g., by Walter Grohl et al. in “Kontakt und Studium”, volume 5, titled “Elastomere—Dicht- und Konstruktionswerkstoffe” (Elastomers—Sealants and Building Materials), 3rd revised edition 1983, published by Expert Verlag, D-71120 Grafenau.

When manufacturing the rollers, the rubber is usually cross-linked by vulcanization to achieve the desired solidity. Elastic thermoplastics and thermoplastic elastomers gain their solidity when the material, which is heated up during processing, cools down, and castable polyurethane systems achieve their solidity by polymerization and cooling down in the casting mold.

The fluorinated polyolefin used for the present invention may be partly or completely fluorinated and possibly to a minor extent contain non-olefinic units in the polymer chain to form a copolymer. Preferably, the fluorinated polyolefin comprises fluorocarbon plastics, in particular fluorinated ethylene propylene copolymer (FEP) or polytetrafluoroethylene (PTFE).

The quantity of the fluorinated polyolefin must be adapted to the relevant base material of the covering and to the desired intensity of the ink-repellent effect. Preferably, when it is admixed as powder or fiber, the fluorinated polyolefin is added in an amount of up to 25% by weight, particularly in an amount of from 5 to 10% by weight with respect to the coating material. It is particularly advantageous to use the fluorinated polyolefin in the form of micro powder or micro fibers and to admix the fluorinated polyolefin as homogeneous as possible to the rubber, elastic thermoplastic, thermoplastic elastomer or casting material. It may also be advantageous to modify the fluorinated polyolefin to improve its incorporation into the roller coating material or to admix the fluorinated polyolefin to a part of the roller coating material first, e.g. to obtain a masterbatch which is subsequently incorporated into the remaining material.

In an other embodiment of the invention, the fluorinated polyolefin is provided in the form of a fibrous material such as a mat, web, fleece, felt, non woven or the like. This fibrous material may be, e.g. by impregnation or coating methods, provided with the rubber, elastic thermoplastic, thermoplastic elastomer or casting material of the roller covering and applied to the surface of a roller or roller core.

The elastomer or the elastic plastic material of the roller covering may also contain usual additives, such as antioxidants, conventional fillers, plasticizers etc. as well as functional additives, i.e. substances comprising functional chemical groups. The latter may be substances for adjusting the hydrophilic properties of the roller surface, such as monomeric, oligomeric or polymeric substances comprising hydrophilic groups, e.g. hydroxyl, carboxyl, carboxylic, amido, silanol and sulfone acids and/or sulfonate groups. Such functional groups, however, may also be constituents of the elastomer or elastic plastic material of the roller covering or of the fluorinated polyolefin.

In a special embodiment of the invention, the roller covering comprises at least two concentric layers made of the elastomer or elastic plastic material, whereas the material of the different layers may be different or the same. In any case, at least the surface layer of the roller covering comprises the fluorinated polyolefin in an amount sufficient to improve the ink-repellent or media-repellent properties of the coating material. Advantageously, the surface layer has a thickness of up to 10 mm, preferably of up to 5 mm.

As usual, prior to use the surface of the roller covering is grinded to give the roller the required diameter, cylindricity and surface roughness. During the employment of the roller it is possible to regenerate the roller surface by cleaning or repeated grinding.

The roller according to the invention may be employed for all processes where the ink-repellent or media-repellent property of the material is of the essence. This is e.g. the case in offset printing machines, where these rollers prove to be particularly advantageous as dampening rollers. Tests with printing machines have shown that considerably less ink spills back from the printing plate cylinder into the dampening system in comparison with conventional rollers, when the newly invented rollers are used in the dampening system. While conventional dampening rollers require several cleaning cycles per shift, the newly invented roller can be operated over several hours without cleaning, so that the cleaning costs and the machine downtime can be considerably reduced.

For use as dampening roller in offset printing machines, the roller covering is adjusted to a hardness of from 15 to 45 Shore A. For other applications or specially designed dampening systems, a higher or lower hardness of the roller covering may be required. In general, however, the hardness will be in the range of from 10 to 100 Shore A.

An additional advantage of the roller covering according to the invention is that the wetting is further improved, while the proportion of isopropyl alcohol in the fountain solution can be drastically reduced. A reduction in the IPA content is particularly desirable for environmental reasons.

### EXAMPLE 1

Production of a NBR/PTFE roller: 10 parts by weight (p/wt) of a PTFE powder (PTFE micro-powder, Dupont) were homogeneously incorporated into 100 p/wt of a conventional NBR rubber compound on a mixing mill. The mixture was applied to the roller core and vulcanized at approximately 150° C. The coating of the vulcanized roller was cut and ground to size, and the roller was installed as transfer roller in the dampening system of an offset printing machine.

For comparison, an other roller was covered with the same NBR compound but without the PTFE powder, and installed as transfer roller in the same printing machine.

In the regular running of the printing operation with mineral oil based heatset inks it was observed that the deposition of ink occurred more slowly on the surface of the NBR/PTFE roller, and thus a cleaning of the roller covering was required at the end of a shift only. In the same time the comparative NBR roller had to be cleaned three times.

### EXAMPLE 2

Production of a multi-layer NBR/PTFE roller: 5 p/wt of a PTFE fiber (Profilen by Lenzing, Austria) are homogeneously incorporated into 100 p/wt of a conventional NBR rubber compound on a mixing mill. A first layer of the conventional NBR rubber compound and a second layer of the NBR/PTFE-fiber compound are applied to a roller core and vulcanized at approximately 150° C. The coating of the vulcanized roller is cut and ground to size. The roller is particularly suitable for use as metering or transfer roller in a dampening system of an offset printing machine.

### EXAMPLE 3

Production of a EPDM/PTFE roller: 7 p/wt of a PTFE fiber (Profilen by Lenzing, Austria) are homogeneously incorporated into 100 p/wt of a conventional EPDM rubber compound in a mixer. The mixture is applied to a roller core and vulcanized at approximately 150° C. The coating of the vulcanized roller is cut and ground to size. The roller is suitable for use in the dampening system of an offset printing machine running with UV-curable printing inks.

### EXAMPLE 4

Production of a PU/PTFE roller: 15 p/wt of a PTFE powder (PTFE micro-powder, Dupont) are homogeneously admixed to 100 p/wt of a conventional liquid two-component polyester-urethane system. The mixture is poured into a roller casting mold and polymerized at approximately 150° C.

Other embodiments of the roller covering according to the invention and methods of producing and fabricating the rollers can be deduced by the expert from the details stated herein under consideration of his general knowledge related to rubber and roller technology.

All the references, including patents described herein are incorporated by reference in their entireties for all useful purposes.

What is claimed is:

1. A roller comprising a roller core and a roller covering being composed of an elastomer or elastic plastic material containing fluorinated polyolefin.

2. The roller of claim 1, wherein said fluorinated polyolefin is selected from fluorocarbon plastics.

3. The roller of claim 1, wherein said fluorinated polyolefin essentially comprises polytetrafluoroethylene or fluorinated ethylene propylene copolymer.

4. The roller of claim 1, wherein said elastomer or elastic plastic material comprises from 0.5 to 25% by weight of said fluorinated polyolefin.

5. The roller of claim 1, wherein said fluorinated polyolefin is applied as powder or fiber, or in the form of a fibrous material.

6. The roller of claim 1, wherein said roller covering comprises one or more concentric layers and wherein said fluorinated polyolefin containing elastomer or elastic plastic material forms a surface layer of said concentric layers.

7. The roller of claim 1, wherein said elastomer or elastic plastic material is based on natural or synthetic rubber, at least one elastic, thermoplastic, at least one thermoplastic elastomer, a castable polyurethane system, or a suitable mixture thereof.

8. The roller of claim 7, wherein said synthetic rubber is selected from acrylonitrile butadiene rubber, ethylene rubber, ethylene-propylene rubber, styrene butadiene rubber, butyl rubber, polyurethane rubber, polyacrylic rubber, epichlorohydrine rubber, silicone rubber, chloroprene rubber, or a suitable mixture thereof.

9. The roller of claim 7, wherein said elastomer or elastic plastic material is based on acrylonitrile butadiene rubber, chloroprene rubber, polyurethane rubber, polyvinyl chloride, or a suitable mixture thereof.

10. The roller of claim 7, wherein said thermoplastic elastomer comprises elastificated polyolefin, styrene block copolymer, copolyester elastomer, thermoplastic polyurethane, or a suitable mixture thereof.

11. The roller of claim 7, wherein said castable polyurethane system comprises a two-component or multi-component polyurethane system.

12. A method of using the roller of claim 1 comprising the step of running the roller in a dampening system of an offset printing machine.

13. A method of making the roller of claim 1 comprising the steps of admixing fluorinated polyolefin
to a rubber compound, to at least one elastic thermoplastic, to at least one thermoplastic elastomer, or to at least one component of a suitable mixture thereof to form a coating material,
or to a liquid mixture of a two-component or multiple-component castable polyurethane system to form a coating composition,
and applying said coating material or coating composition to a roller core.

14. The method of claim 13, wherein said coating material or coating composition is applied to form a surface layer of a roller covering to said roller core.

15. A method of making the roller of claim 1 comprising the steps of impregnating or coating a fibrous material being composed of fluorinated polyolefin with natural or synthetic rubber, at least one elastic thermoplastic, at least one thermoplastic elastomer (TPE), a castable polyurethane system, or a suitable mixture thereof, and covering a roller core or roller with said impregnated or coated fibrous material.

16. A method of improving the ink-repellent properties of a roller covering being composed of an elastomer or elastic plastic material comprising the step of incorporating fluorinated polyolefin into said elastomer or elastic plastic material.

17. The method of claim 16, wherein said fluorinated polyolefin is selected from fluorocarbon plastics.

18. The method of claim 16, wherein said fluorinated polyolefin is applied as powder, fiber or fibrous material.
